(19) United States
(12) Patent Application Publication
(10) Pub. No.: US 2020/0149676 A1
(43) Pub. Date: May 14, 2020

(54) Insulator And Method Of Manufacturing The Same

(71) Applicant: Tyco Electronics (Shanghai) Co. Ltd., Shanghai (CN)

(72) Inventors: Lizhang Yang, Swindon (GB); Yugang Li, Shanghai (CN); Jian Li, Shanghai (CN)

(73) Assignee: Tyco Electronics (Shanghai) Co. Ltd., Shanghai (CN)

(21) Appl. No.: 16/742,307

(22) Filed: Jan. 14, 2020

Related U.S. Application Data
(63) Continuation of application No. PCT/EP2018/068166, filed on Jul. 5, 2018.

(30) Foreign Application Priority Data
Jul. 14, 2017 (CN) 201710574130.X

(51) Int. Cl. F16L 59/147; F16L 59/16

(52) U.S. Cl. CPC F16L 59/147; H01B 17/32; F16L 59/168

(57) ABSTRACT

An insulator includes an insulation tube, an insulation foam body disposed in the insulation tube, and a curable adhesive disposed between the insulation foam body and an inner wall of the insulation tube. The curable adhesive after being cured is softer than both the insulation foam body and the insulation tube.

### CROSS-REFERENCE TO RELATED APPLICATIONS

This application is a continuation of PCT International Application No. PCT/EP2018/068166, filed on Jul. 5, 2018, which claims priority under 35 U.S.C. § 119 to Chinese Patent Application No. 201710574130.X, filed on Jul. 14, 2017.

### FIELD OF THE INVENTION

The present invention relates to an insulator and, more particularly, to an insulator for use in electric insulation.

### BACKGROUND

An insulator for outdoor applications generally includes a porcelain insulator or a composite insulator. The composite insulator is widely used in an electric insulation industry because it has advantages such as a light weight and a low manufacturing cost. A composite insulator generally includes a hollow insulation tube, an insulation rubber umbrella skirt formed on an outer wall of the insulation tube, and an insulation gas or a polyurethane foam material provided in the insulation tube.

When the composite insulator includes the insulation gas, the insulation gas easily leaks out of the insulation tube, which may cause a safety issue. Thereby, it is necessary to install a monitoring device to monitor the change of the insulation gas inside the insulation tube, so as to timely detect the leakage of the insulation gas.

When the composite insulator includes the polyurethane foam in the insulation tube, the polyurethane foam material easily peels off from an inner wall of the insulation tube as shrinkage of the polyurethane foam material is much higher than that of the insulation tube. Thereby, after many cycles of heat expansion and cold contraction, the polyurethane foam material will be peeled off from the inner wall of the insulation tube, resulting in a gap between the polyurethane foam material and the inner wall of the insulation tube. In such a case, external water vapor will easily enter into the insulator through the gap, which may cause the insulator to easily breakdown by an electric current, seriously affecting the safety performance of the insulator.

### SUMMARY

An insulator includes an insulation tube, an insulation foam body disposed in the insulation tube, and a curable adhesive disposed between the insulation foam body and an inner wall of the insulation tube. The curable adhesive after being cured is softer than both the insulation foam body and the insulation tube.

### BRIEF DESCRIPTION OF THE DRAWINGS

The invention will now be described by way of example with reference to the accompanying Figures, of which:

FIG. 1 is a schematic cross-sectional view of an insulator according to an embodiment;

FIG. 2 is a schematic cross-sectional view of an insulator according to another embodiment;

FIG. 3 is a schematic cross-sectional view of an insulator according to another embodiment;

FIG. 4 is a schematic cross-sectional view of an insulator according to another embodiment; and

FIG. 5 is a schematic cross-sectional view of an insulator according to another embodiment.

### DETAILED DESCRIPTION OF THE EMBODIMENT(S)

Exemplary embodiments of the present disclosure will be described hereinafter in detail with reference to the accompanying drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

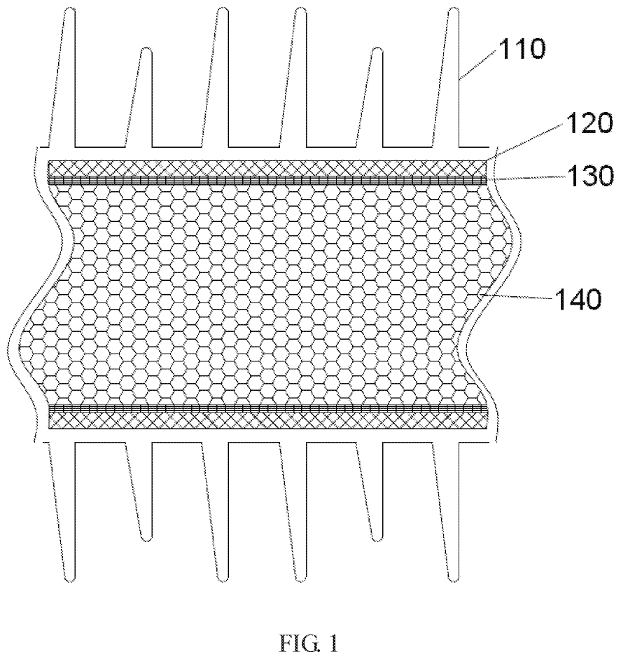

An insulator according to an embodiment, as shown in FIG. 1, includes a silicone rubber umbrella skirt 110, an insulation tube 120, and an insulation foam body 140. The silicone rubber umbrella skirt 110 is formed on an outer wall of the insulation tube 120. The insulation foam body 140 is provided in the insulation tube 120.

As shown in FIG. 1, in an embodiment, a curable adhesive 130 is provided between the insulation foam body 140 and an inner wall of the insulation tube 120. The curable adhesive 130 after being cured is softer than both the insulation foam body 140 and the insulation tube 120. Thereby, the deformability of the curable adhesive 130 after being cured is larger than that of the insulation foam body 140 and the insulation tube 120, so that it may effectively prevent a gap from being generated between the insulation foam body 140 and the inner wall of the insulation tube 120. In this way, the electric insulation performance and the safety performance of the insulator may be improved.

As shown in FIG. 1, in an embodiment, the insulation foam body 140 is a columnar insulation foam body 140 which has a length less than or equal to that of the insulation tube 120 and has an outer diameter slightly less than an inner diameter of the insulation tube 120.

In an embodiment, the columnar insulation foam body 140 may be manufactured in advance and then inserted into the insulation tube 120. After the columnar insulation foam body 140 is inserted into the insulation tube 120, a liquid curable adhesive 130 is injected into a gap between the columnar insulation foam body 140 and the insulation tube 120. Then, the curable adhesive 130 is cured, for example, by heating it to a predetermined temperature or placing it in a room temperature environment for a period of time. After the curable adhesive 130 is cured, the columnar insulation foam body 140 is adhered to the inner wall of the insulation tube 120 by the curable adhesive 130.

In an exemplary embodiment, the insulation foam body 140 may be made of polyurethane, polypropylene or polystyrene. The insulation foam body 140 may have a closed cell foaming structure. In an exemplary embodiment, the curable adhesive 130 may include a curable silica gel. In an exemplary embodiment, the insulation tube 120 may include a glass fiber epoxy insulation tube.

A method of manufacturing the insulator shown in FIG. 1 includes the steps of: manufacturing an insulation foam body 140; filling an insulation tube 120 with the insulation foam body 140; injecting a curable adhesive 130 into a gap between the insulation foam body 140 and the insulation tube 120; and curing the curable adhesive 130.

In another embodiment, a method of manufacturing the insulator shown in FIG. 1, includes the steps of: coating an inner wall of an insulation tube 120 with a layer of curable adhesive 130; curing the curable adhesive 130; and filling the insulation tube 120 with an insulation foam material to form an insulation foam body 140 in the insulation tube 120.

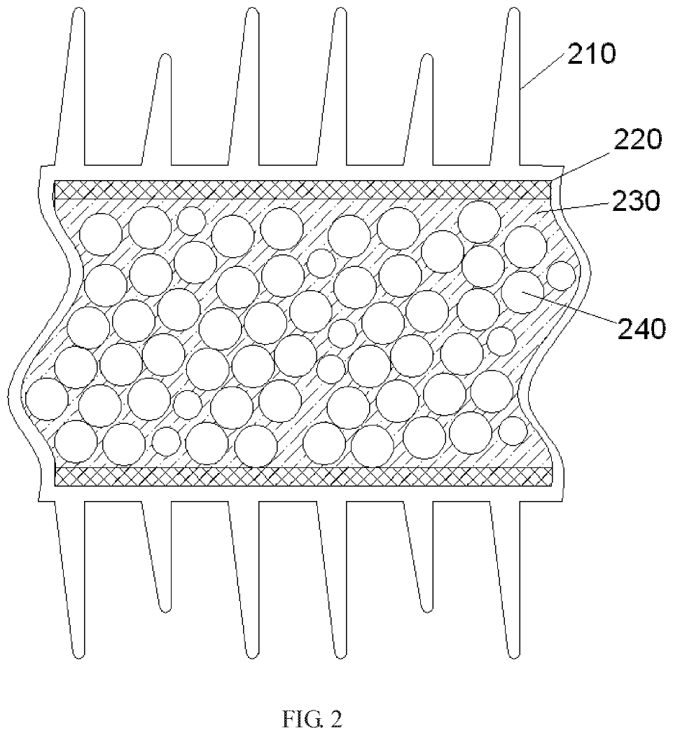

An insulator according to another embodiment, as shown in FIG. 2, mainly includes a silicone rubber umbrella skirt 210, an insulation tube 220, and an insulation foam body. The silicone rubber umbrella skirt 210 is formed on an outer wall of the insulation tube 220. The insulation foam body is provided in the insulation tube 220.

As shown in FIG. 2, in an embodiment, a curable adhesive 230 is provided between the insulation foam body and an inner wall of the insulation tube 220. The curable adhesive 230 after being cured is softer than both the insulation foam body and the insulation tube 220. Thereby, the deformation ability of the curable adhesive 230 after being cured is larger than that of the insulation foam body and the insulation tube 220, so that it may effectively prevent a gap from being generated between the insulation foam body and the inner wall of the insulation tube 220. In this way, the electric insulation performance and the safety performance of the insulator may be improved.

As shown in FIG. 2, in an embodiment, the insulation foam body includes insulation foam particles 240. The insulation foam particles 240 may be mixed with the curable adhesive 230 and injected into the insulation tube 220 together with the curable adhesive 230. Then, the curable adhesive 230 is cured, for example, by heating it to a predetermined temperature or placing it in a room temperature environment for a period of time. After the curable adhesive 230 is cured, the insulation foam particles 240 are adhered to the inner wall of the insulation tube 220 by the curable adhesive 230.

In another embodiment, as shown in FIG. 2, the insulation foam body includes insulation foam particles 240. The insulation foam particles 240 are filled into the insulation tube 220, then the curable adhesive 230 is injected into the insulation tube 220 and mixed with the insulation foam particles 240. Thereafter, the curable adhesive 230 is cured, for example, by heating it to a predetermined temperature or placing it in a room temperature environment for a period of time. After the curable adhesive 230 is cured, the insulation foam particles 240 are adhered to the inner wall of the insulation tube 220 by the curable adhesive 230.

As shown in FIG. 2, in an embodiment, each of the insulation foam particles 240 has a spherical shape. However, the present disclosure is not limited to this. The insulation foam particles 240 may have a cube shape, a cuboid shape, or an ellipsoid shape in other embodiments.

In an exemplary embodiment, the insulation foam body 240 may be made of polyurethane, polypropylene or polystyrene. In an exemplary embodiment, the insulation foam body 240 may have a closed cell foaming structure. In an exemplary embodiment, the curable adhesive 230 may include a curable silica gel. In an exemplary embodiment, the insulation tube 220 may include a glass fiber epoxy insulation tube.

A method of manufacturing the insulator shown in FIG. 2 includes the steps of: manufacturing insulation foam particles 240; mixing the insulation foam particles 240 with a liquid curable adhesive 230; injecting the insulation foam particles 240 together with the liquid curable adhesive 230 into an insulation tube 220; and curing the curable adhesive 230.

In another embodiment, a method of manufacturing the insulator shown in FIG. 2 includes the steps of: manufacturing insulation foam particles 240; injecting a liquid curable adhesive 230 into an insulation tube 220; filling the insulation tube 220 with the insulation foam particles 240, and mixing the insulation foam particles 240 with the liquid curable adhesive 230; and curing the curable adhesive 230.

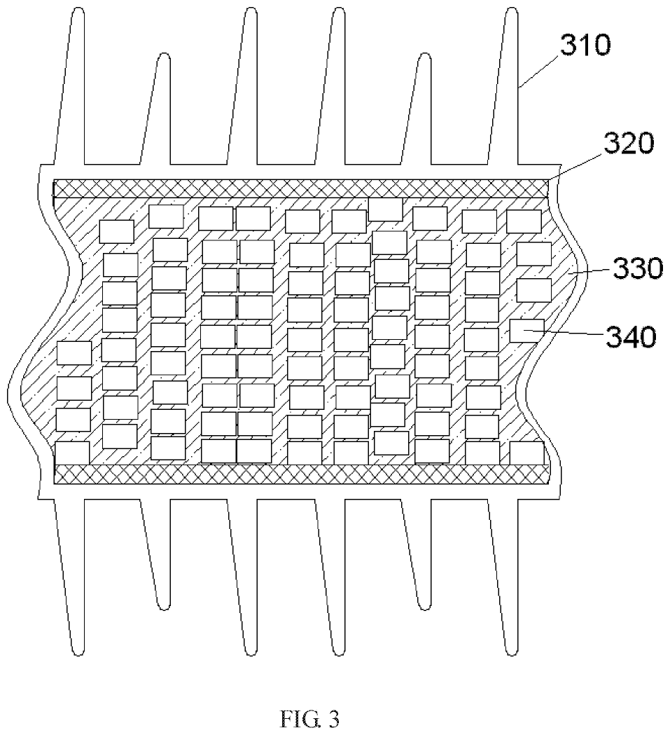

An insulator according to another embodiment, as shown in FIG. 3, includes a silicone rubber umbrella skirt 310, an insulation tube 320, and an insulation foam body. The silicone rubber umbrella skirt 310 is formed on an outer wall of the insulation tube 320. The insulation foam body is provided in the insulation tube 320.

As shown in FIG. 3, in an embodiment, a curable adhesive 330 is provided between the insulation foam body and an inner wall of the insulation tube 320. The curable adhesive 330 after being cured is softer than both the insulation foam body and the insulation tube 320. Thereby, the deformation ability of the curable adhesive 330 after being cured is larger than that of the insulation foam body and the insulation tube 320, so that it may effectively prevent a gap from being generated between the insulation foam body and the inner wall of the insulation tube 320. In this way, the electric insulation performance and the safety performance of the insulator may be improved.

As shown in FIG. 3, in an embodiment, the insulation foam body includes insulation foam particles 340. The insulation foam particles 340 may be mixed with the curable adhesive 330 and injected into the insulation tube 320 together with the curable adhesive 330. Then, the curable adhesive 330 is cured, for example, by heating it to a predetermined temperature or placing it in a room temperature environment for a period of time. After the curable adhesive 330 is cured, the insulation foam particles 340 are adhered to the inner wall of the insulation tube 320 by the curable adhesive 330.

As shown in FIG. 3, in an embodiment, each of the insulation foam particles 340 has a cube shape. In other embodiments, of the insulation foam particles 340 may have a spherical shape, a cuboid shape, or an ellipsoid shape.

In an exemplary embodiment, the insulation foam body may be made of polyurethane, polypropylene or polystyrene. In an exemplary embodiment, the insulation foam body may have a closed cell foaming structure. In an exemplary embodiment, the curable adhesive 330 may include a curable silica gel. In an exemplary embodiment, the insulation tube 320 may include a glass fiber epoxy insulation tube.

A method of manufacturing the insulator shown in FIG. 3 includes the steps of:

manufacturing insulation foam particles 340; mixing the insulation foam particles 340 with a liquid curable adhesive 330; injecting the insulation foam particles 340 together with the liquid curable adhesive 330 into an insulation tube 320; and curing the curable adhesive 330.

In another embodiment, a method of manufacturing the insulator shown in FIG. 3 includes the steps of: manufacturing insulation foam particles 340; injecting a liquid curable adhesive 330 into an insulation tube 320; filling the insulation tube 320 with the insulation foam particles 340, and mixing the insulation foam particles 340 with the liquid curable adhesive 330; and curing the curable adhesive 330.

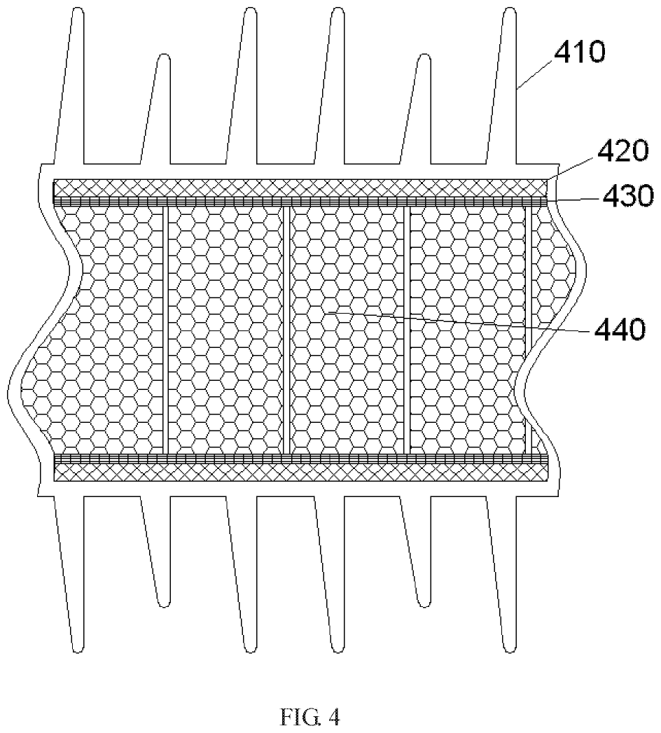

An insulator according to another embodiment, as shown in FIG. 4, includes a silicone rubber umbrella skirt 410, an insulation tube 420, and an insulation foam body. The silicone rubber umbrella skirt 410 is formed on an outer wall of the insulation tube 420. The insulation foam body is provided in the insulation tube 420.

As shown in FIG. 4, in an embodiment, a curable adhesive 430 is provided between the insulation foam body and an inner wall of the insulation tube 420. The curable adhesive 430 after being cured is softer than both the insulation foam body and the insulation tube 420. Thereby, the deformation ability of the curable adhesive 430 after being cured is larger than that of the insulation foam 440 and the insulation tube 420, so that it may effectively prevent a gap from being generated between the insulation foam body and the inner wall of the insulation tube 420. In this way, the electric insulation performance and the safety performance of the insulator may be improved.

As shown in FIG. 4, in an embodiment, the insulation foam body includes a plurality of columnar insulation foam segments 440. Each of the columnar insulation foam segments 440 has a length less than that of the insulation tube 420 and an outer diameter slightly less than an inner diameter of the insulation tube 420.

Each of the columnar insulation foam segments 440 may be manufactured in advance and then filled into the insulation tube 420. After the columnar insulation foam segments 440 are provided in the insulation tube 420, a liquid curable adhesive 430 is injected into a gap between the columnar insulation foam segments 440 and the insulation tube 420. Then, the curable adhesive 430 is cured, for example, by heating it to a predetermined temperature or placing it in a room temperature environment for a period of time. After the curable adhesive 430 is cured, the columnar insulation foam segments 440 are adhered to the inner wall of the insulation tube 420 by the curable adhesive 430.

In an exemplary embodiment, the insulation foam body may be made of polyurethane, polypropylene, or polystyrene. In an exemplary embodiment, the insulation foam body may have a closed cell foaming structure. In an exemplary embodiment, the curable adhesive 430 may include a curable silica gel. In an exemplary embodiment, the insulation tube 420 may include a glass fiber epoxy insulation tube.

A method of manufacturing the insulator shown in FIG. 4 includes the steps of: manufacturing a plurality of columnar insulation foam segments 440; filling an insulation tube 420 with the plurality of columnar insulation foam segments 440; injecting a liquid curable adhesive 430 into a gap between the columnar insulation foam segments 440 and the insulation tube 420; and curing the curable adhesive 430.

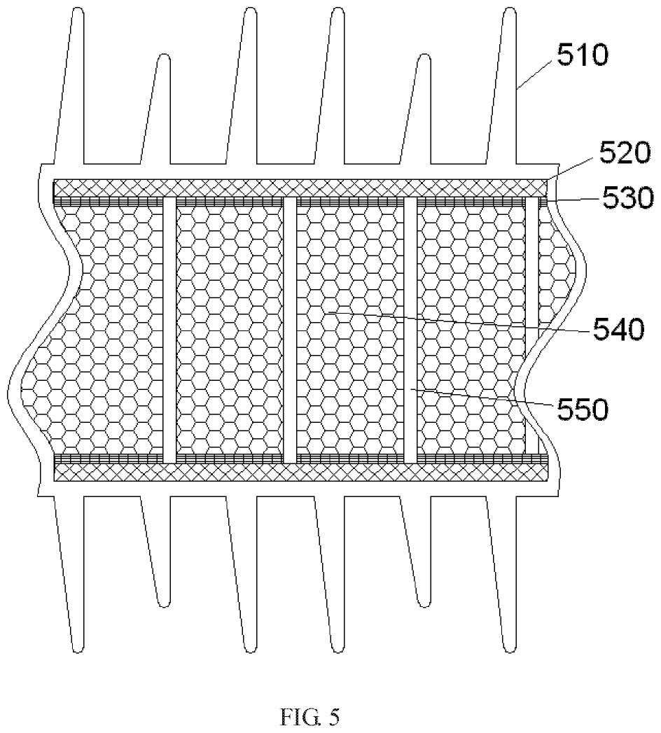

An insulator according to another embodiment, as shown in FIG. 5, is different from the insulator shown in FIG. 4 mainly in that an insulation separation member 550 is provided between each two adjacent columnar insulation foam segments 540. Because each two adjacent columnar insulation foam segments 540 are separated by the insulation separation member 550, each columnar insulation foam segment 540 may be individually adhered to the inner wall of the insulation tube 520 by the curable adhesive 530. In this way, it may reduce difficulty in manufacturing the insulator. Except for the above descriptions, the insulator shown in FIG. 5 is substantially the same as the insulator shown in FIG. 4, and further descriptions about the insulator of FIG. 5 are omitted herein.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

What is claimed is:

1. An insulator, comprising:
an insulation tube;
an insulation foam body disposed in the insulation tube; and
a curable adhesive disposed between the insulation foam body and an inner wall of the insulation tube, the curable adhesive after being cured is softer than both the insulation foam body and the insulation tube.

2. The insulator of claim 1, wherein the insulation foam body is a columnar insulation foam body having a length less than or equal to a length of the insulation tube and an outer diameter less than an inner diameter of the insulation tube.

3. The insulator of claim 2, wherein the columnar insulation foam body is disposed in the insulation tube and the curable adhesive is injected into a gap between the columnar insulation foam body and the insulation tube.

4. The insulator of claim 1, wherein the insulation foam body has a plurality of insulation foam particles mixed with the curable adhesive in the insulation tube.

5. The insulator of claim 4, wherein each of the insulation foam particles has a spherical shape, a cube shape, a cuboid shape, or an ellipsoid shape.

6. The insulator of claim 1, wherein the insulation foam body has a plurality of columnar insulation foam segments.

7. The insulator of claim 6, wherein each of the columnar insulation foam segments has a length less than a length of the insulation tube and an outer diameter less than an inner diameter of the insulation tube.

8. The insulator of claim 7, wherein the columnar insulation foam segments are disposed in the insulation tube and the curable adhesive is injected into a gap between the columnar insulation foam segments and the insulation tube.

9. The insulator of claim 8, wherein an insulation separation member is disposed between each pair of adjacent columnar insulation foam segments.

10. The insulator of claim 1, wherein the insulation foam body is made of polyurethane, polypropylene, or polystyrene.

11. The insulator of claim 11, wherein the insulation foam body has a closed cell foaming structure.

12. The insulator of claim 1, wherein the curable adhesive is a curable silica gel and/or the insulation tube is a glass fiber epoxy insulation tube.

13. The insulator of claim 1, further comprising a silicone rubber umbrella skirt formed on an outer wall of the insulation tube.

14. A method of manufacturing an insulator, comprising:
providing an insulation tube;
filling the insulation tube with an insulation foam material and a curable adhesive; and
curing the curable adhesive, the curable adhesive after being cured is softer than both the insulation foam material and the insulation tube.

15. The method of claim 14, further comprising manufacturing an insulation foam body prior to the filling step, the filling step includes filling the insulation tube with the insulation foam body and injecting the curable adhesive into a gap between the insulation foam body and the insulation tube.

16. The method of claim 14, further comprising manufacturing a plurality of insulation foam particles.

17. The method of claim 16, wherein the filling step includes mixing the insulation foam particles with a liquid curable adhesive and injecting the insulation foam particles together with the liquid curable adhesive into the insulation tube.

18. The method of claim 16, wherein the filling step includes injecting a liquid curable adhesive into the insulation tube, filling the insulation tube with the insulation foam particles, and mixing the insulation foam particles with the liquid curable adhesive.

19. A method of manufacturing an insulator, comprising:
coating an inner wall of an insulation tube with a layer of a curable adhesive;
curing the curable adhesive; and
filling the insulation tube with an insulation foam material to form an insulation foam body in the insulation tube, the curable adhesive after being cured is softer than both the insulation foam body and the insulation tube.
